(19) United States
(12) Patent Application Publication
(10) Pub. No.: US 2026/0177025 A1
(43) Pub. Date: Jun. 25, 2026

(54) METHOD AND SYSTEM FOR STARTING MOTORCYCLE ENGINE

(71) Applicant: MOTIVE POWER INDUSTRY CO., LTD., Changhua County (TW)

(72) Inventor: JOHN-SUN WANG, Taipei City (TW)

(73) Assignee: MOTIVE POWER INDUSTRY CO., LTD., Changhua County (TW)

(21) Appl. No.: 19/399,669

(22) Filed: Nov. 25, 2025

(30) Foreign Application Priority Data
Dec. 23, 2024 (TW) 113150182

(51) Int. Cl. F02N 11/08; F02N 11/04

(52) U.S. Cl. CPC F02N 11/0862; F02N 11/04

(57) ABSTRACT

A method for starting a motorcycle engine is performed through an engine starting control system including a controller, a power supply apparatus coupled to the controller, and an integrated starter and generator coupled to the controller, the power supply apparatus, and the motorcycle engine. The method includes driving the integrated starter and generator to perform reverse operation at a reverse operation constant torque value within a reverse operation time until the reverse operation time ends; controlling the power supply apparatus to output a forward operation constant current to the integrated starter and generator after the integrated starter and generator stops the reverse operation, to perform forward operation; and starting the motorcycle engine through the integrated starter and generator when a forward operation angular velocity value is greater than or equal to an expected value. The method starts the motorcycle engine effectively. Furthermore, a corresponding system is also provided.

This non-provisional application claims priority under 35 U.S.C. § 119(a) on Patent Application No(s). 113150182 filed in Taiwan, R.O.C. on Dec. 23, 2024, the entire contents of which are hereby incorporated by reference.

### BACKGROUND OF THE INVENTION

### 1. Field of the Invention

This application relates to a method and system for starting a motorcycle engine.

### 2. Description of the Related Art

Conventionally, a motorcycle uses a carbon brush motor to start a motorcycle engine, so that the motorcycle engine can function after being started. However, because the motorcycle engine has gas compression resistance, valve spring resistance, frictional resistance, and the like, the carbon brush motor needs to use a reduction gear to increase torque, to drive the crankshaft of the motorcycle engine to rotate, thereby smoothly starting up or starting the motorcycle engine.

Subsequently, in order to reduce a weight and increase starting quality, in practice, an integrated starter and generator (ISG) may be introduced, which is characterized in that a flywheel magneto coaxial with the crankshaft of the motorcycle engine is used as the foregoing carbon brush motor. In this way, when a user intends to start the motorcycle engine, energy is injected to the flywheel magneto, so that the flywheel magneto becomes a motor, thereby driving the crankshaft of the motorcycle engine to rotate and successfully starting the motorcycle engine. In other words, the integrated starter and generator may be configured to drive the crankshaft of the motorcycle engine, to rotate the crankshaft of the motorcycle engine to a certain speed and then perform a combustion operation, thereby successfully starting the motorcycle engine.

It should be noted that, when the crankshaft of the motorcycle engine is driven, the crankshaft of the motorcycle engine may be obstructed by the frictional resistance, the compression resistance, and the valve spring resistance, so that the crankshaft of the motorcycle engine needs to have a sufficient torsional force to overcome the foregoing resistance, thereby successfully starting the motorcycle engine. Because the integrated starter and generator is coaxial with the crankshaft of the motorcycle engine, there is no additional space to install the reduction gear to increase the torsional force of the crankshaft of the motorcycle engine, so that in practice, a larger amount of current needs to be inputted to the integrated starter and generator to increase the torsional force of the crankshaft of the motorcycle engine, thereby successfully starting the motorcycle engine. However, although the motorcycle engine can be started successfully by increasing the amount of current, problems such as heating of wires and/or an increase in power consumption costs may be caused due to an increase in the amount of current.

In the related art, for example, a patent document of Taiwan Patent No. 390939 filed by Honda Motor Co., Ltd. teaches that before the motorcycle engine is started, the integrated starter and generator is used to rotate the crankshaft of the motorcycle engine to an optimal pre-starting position, and then the integrated starter and generator is driven to operate forward, to successfully start the motorcycle engine.

### BRIEF SUMMARY OF THE INVENTION

Although a motorcycle engine may be successfully started through an integrated starter and generator at an optimal pre-starting position and with a relatively small amount of current, and heat generated by wire energization is reduced and/or time consumed for starting is reduced, it must be ensured in advance that the crankshaft of the motorcycle engine has been rotated to the optimal pre-starting position.

In other words, to start the motorcycle engine with a relatively small amount of current, in the related art, a crankshaft positioning sensor or another apparatus that can determine a position of the crankshaft of the motorcycle engine needs to be additionally installed. For example, in the related art, positioning sensors need to be additionally installed on a rotor, a stator, and a crankshaft, to ensure that relative positions among the rotor, stator, and crankshaft are well-defined, thereby ensuring that the crankshaft of the motorcycle engine is in the optimal pre-starting position.

However, additionally used positioning sensors in the related art may cause problems such as an increase in costs needed for the positioning sensors, installation space needed to be reserved, and/or design complexity of an entire system. Additionally, not using additional positioning sensors may cause problems such as an excessively large starting current, heating of wires, and/or an increase in power consumption costs.

Therefore, how to resolve the foregoing problems encountered in starting the motorcycle engine and effectively start the motorcycle engine at lower costs becomes a problem that is urgently intended to be resolved in the technical field to which this application belongs.

To resolve the foregoing problem, this application provides a method for starting a motorcycle engine, performed through an engine starting control system, where the engine starting control system includes a controller, a power supply apparatus coupled to the controller, and an integrated starter and generator separately coupled to the controller and the power supply apparatus, and the integrated starter and generator in the engine starting control system is coupled to the motorcycle engine. The method includes the following steps: driving, through the controller, the integrated starter and generator to perform reverse operation at a reverse operation constant torque value within a reverse operation time until the reverse operation time ends, where a reverse operation torque of the integrated starter and generator driven by the reverse operation constant torque value is greater than a frictional resistance value and less than a maximum resistance value of a valve spring resistance; controlling, through the controller, the power supply apparatus to output a forward operation constant current to the integrated starter and generator after the integrated starter and generator stops the reverse operation, to drive the integrated starter and generator to perform forward operation, where a forward operation torque of the integrated starter and generator driven by an amount of the forward operation constant current is greater than a sum of the frictional resistance value and a current resistance value of the valve spring resistance; and starting the motorcycle engine through the integrated starter and generator when a forward operation angular velocity value of the motorcycle engine driven by the integrated starter and generator is greater than or equal to an expected value during the forward operation of the integrated starter and generator.

In some embodiments, the method for starting the motorcycle engine further includes the following steps: driving, through the controller, the integrated starter and generator again to perform reverse operation at the reverse operation constant torque value when the forward operation angular velocity value of the motorcycle engine driven by the integrated starter and generator is less than the expected value during the forward operation of the integrated starter and generator; and controlling, through the controller, the power supply apparatus again to output the forward operation constant current to the integrated starter and generator when a force balance static state is reached between an exhaust valve spring resistance and a reverse operation driving force of the integrated starter and generator during a period in which the integrated starter and generator performs the reverse operation again, to drive the integrated starter and generator to perform forward operation again.

In some embodiments, the method for starting the motorcycle engine further includes the following steps: receiving, through the controller, a rotation angle value of the integrated starter and generator; determining, through the controller, whether the rotation angle value of the integrated starter and generator is greater than an engine worn angle preset value when the integrated starter and generator stops the reverse operation as the reverse operation time ends; and determining, through the controller, that the motorcycle engine is in an engine worn state when the rotation angle value of the integrated starter and generator is greater than the engine worn angle preset value.

In some embodiments, the method for starting the motorcycle engine further includes the following steps: receiving, through the controller, a rotation angle value of the integrated starter and generator; determining, through the controller, whether the rotation angle value of the integrated starter and generator within a determination time is less than an engine stuck angle preset value when the integrated starter and generator performs the forward operation; and determining, through the controller, that the motorcycle engine is in an engine stuck state when the rotation angle value of the integrated starter and generator within the determination time is less than the engine stuck angle preset value.

In some embodiments, the engine starting control system does not include a crankshaft positioning sensor.

In addition, this application also provides a system for starting a motorcycle engine, where the system is coupled to a motorcycle engine, and the system includes: a controller; a power supply apparatus, coupled to the controller; and an integrated starter and generator, separately coupled to the controller, the power supply apparatus, and the motorcycle engine, where the system is configured to perform the method for starting a motorcycle engine according to this application, to start the motorcycle engine.

In some embodiments, the system for starting the motorcycle engine does not include a crankshaft positioning sensor.

Therefore, by using the technical methods provided in this application, beneficial effects that cannot be achieved in the previous art can be achieved. Specifically, one of the beneficial effects that can be achieved by this application is that a motorcycle engine is started with a relatively small amount of current without additionally installing positioning sensors, thereby effectively reducing costs of starting the motorcycle engine.

### BRIEF DESCRIPTION OF THE DRAWINGS

FIG. 1 is a schematic block diagram of a system for starting a motorcycle engine according to this application.

FIG. 2 is a flowchart of a method for starting a motorcycle engine according to a first embodiment of this application.

FIG. 3 is a schematic diagram of a waveform of a relationship between a crankshaft position and crankshaft resistance.

FIG. 4 is a schematic diagram of a waveform of a relationship between a crankshaft position and crankshaft resistance.

FIG. 5 is a flowchart of a method for starting a motorcycle engine according to a second embodiment of this application.

FIG. 6 is a schematic diagram of a waveform of a relationship between a crankshaft position and crankshaft resistance.

FIG. 7 is a flowchart of a method for starting a motorcycle engine according to a third embodiment of this application.

FIG. 8 is a flowchart of a method for starting a motorcycle engine according to a fourth embodiment of this application.

### DETAILED DESCRIPTION OF THE INVENTION

In this application, content of this application will be described in detail through the following embodiments and the accompanying drawings, so as to help a person of ordinary skill in the art to which this application belongs to understand the objectives, features, and effects of this application.

It should be noted that, various steps described in this application may be performed in sequence, in reverse sequence, or by appropriately altering or skipping an order during the control process. It should be noted that, “a first step may be performed after a second step” described in this application may be expressed as that “the first step is directly performed after the second step is performed” and/or “after the second step is performed, another step (for example, a third step) is performed first and then the first step is performed”.

In addition, in the content described in this application, it should be noted that the terms such as “first”, “second”, and “third” are used to distinguish differences between elements, and are not intended to limit the elements themselves or to indicate a specific order of the elements. It should be noted that in the content described below, the same elements or steps may be denoted by the same reference signs.

In addition, the term “coupled” described in this application may be expressed as “directly connected” and/or “indirectly connected”. Specifically, “a first element is configured to be coupled to a second element” may be expressed as that “the first element is configured to be directly connected to the second element” and/or “the first element is configured to be indirectly connected to the second element”.

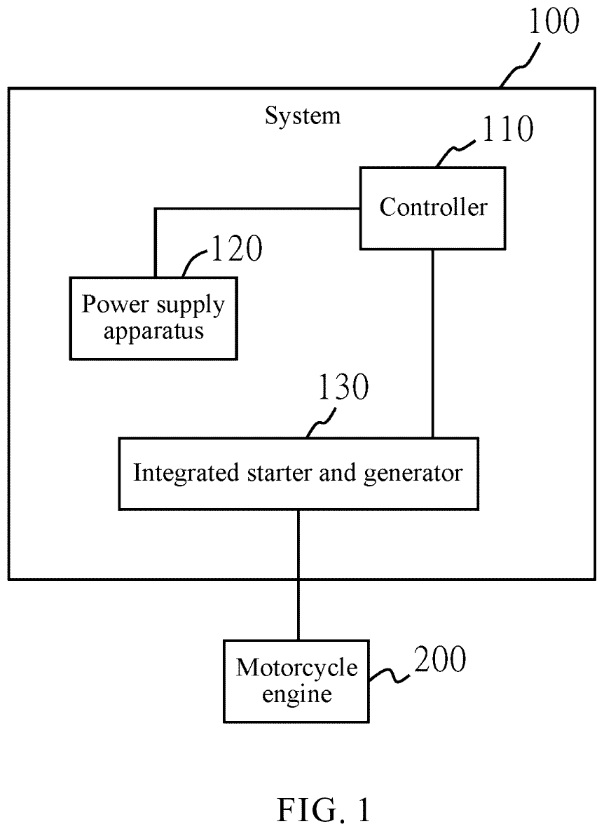

Referring to FIG. 1, FIG. 1 is a schematic block diagram of a system 100 for starting a motorcycle engine according to this application. As shown in FIG. 1, the system 100 (which may also be referred to as an engine starting control system described in this application) for starting a motorcycle engine may include a controller 110, a power supply apparatus 120, and an integrated starter and generator 130, to start a motorcycle engine 200 by using the system 100 for starting a motorcycle engine. More specifically, because the integrated starter and generator 130 in the system 100 for starting a motorcycle engine is coupled to the motorcycle engine 200, the system 100 may start the motorcycle engine 200 by using the integrated starter and generator 130 based on control of the controller 110. The elements are respectively described in more detail below.

The controller 110 is configured to be separately coupled to the power supply apparatus 120 and the integrated starter and generator 130, to control a current outputted by the power supply apparatus 120 and/or an operation mode of the integrated starter and generator 130. In some embodiments, the controller 110 may be a finished product known by a person of ordinary skill in the art to which this application belongs. Also, the controller 110 may be separately coupled to the power supply apparatus 120 and the integrated starter and generator 130 by using a transmission line known by a person of ordinary skill in the art to which this application belongs.

The power supply apparatus 120 is configured to output, according to a control command from the controller 110, a current corresponding to the received control command to the integrated starter and generator 130, for example, a reverse operation constant current or a forward operation constant current, thereby driving the integrated starter and generator 130 to perform reverse operation or forward operation. In some embodiments, the power supply apparatus 120 may be a finished product known by a person of ordinary skill in the art to which this application belongs.

The integrated starter and generator 130 is configured to perform operation according to the control command sent by the controller 110 and/or the current outputted by the power supply apparatus 120, for example, perform reverse operation or forward operation, thereby driving the motorcycle engine 200 to rotate. In some embodiments, the integrated starter and generator 130 may be a finished product known by a person of ordinary skill in the art to which this application belongs.

The motorcycle engine 200 is configured to be coupled to the integrated starter and generator 130, to be started by the operation of the integrated starter and generator 130, thereby enabling the motorcycle engine 200 to function. In some embodiments, the motorcycle engine 200 may be a finished product known by a person of ordinary skill in the art to which this application belongs, for example, may be, but is not limited to, a 125 cc four-stroke single-cylinder gasoline engine.

The foregoing system 100 for starting a motorcycle engine can perform any method of the methods for starting a motorcycle engine described in this application, so that in a case in which a positioning sensor, for example, a crankshaft positioning sensor, does not need to be installed additionally, the motorcycle engine 200 can be started with a relatively small amount of current, thereby effectively reducing costs of starting the motorcycle engine 200. In other words, the system 100 for starting a motorcycle engine can get rid of an installation requirement of the crankshaft positioning sensor, to reduce construction costs and installation space of the system 100 and/or design complexity of the system 100, and start the motorcycle engine 200 with a relatively small amount of current, thereby reducing power consumption costs and avoiding an impact caused by heating of wires.

In addition, in this configuration, the system 100 has an advantage of model adaptability, that is, the integrated starter and generator 130 does not need to be installed at a specific position with the motorcycle engine 200.

Additionally, in some embodiments, the system 100 for starting a motorcycle engine may not include the crankshaft positioning sensor (not shown in the figure). In other words, even if the system 100 does not include the crankshaft positioning sensor, the system 100 can also start the motorcycle engine 200 with a relatively small amount of current.

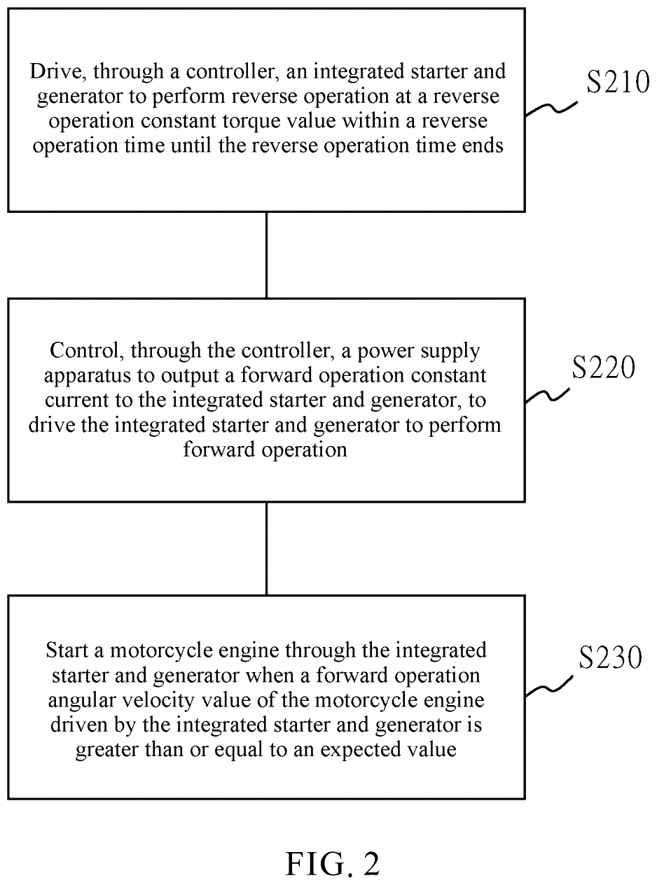

Referring to FIG. 2, FIG. 2 is a flowchart of a method for starting a motorcycle engine according to a first embodiment of this application. Using FIG. 2 as an example, the method for starting a motorcycle engine may be performed by using the system 100 for starting a motorcycle engine shown in FIG. 1, where the method may include steps S210, S220, and S230. The steps are respectively described in more detail below.

In some embodiments, step S220 may be performed after step S210, and step S230 may be performed after step S220.
Step S210: Drive, by using the controller 110 in the system 100, the integrated starter and generator 130 to perform reverse operation at a reverse operation constant torque value within a reverse operation time until the reverse operation time ends, where a reverse operation torque of the integrated starter and generator 130 driven by the reverse operation constant torque value is greater than a frictional resistance value and is less than a maximum resistance value of a valve spring resistance. In this way, the integrated starter and generator 130 continues to perform the reverse operation within the reverse operation time, and the integrated starter and generator 130 stops the reverse operation until the reverse operation time ends, so that a crankshaft of the motorcycle engine 200 is driven to a specific position through reverse operation during this period. In other words, by performing step S210, the controller 110 can drive the integrated starter and generator 130 to perform the reverse operation, so that the crankshaft of the motorcycle engine 200 is driven to a rear edge of the valve spring resistance in an air inlet interval shown in FIG. 4 below, thereby reducing resistance that needs to be overcome to start the motorcycle engine 200.

In some embodiments, the reverse operation time may be preset to, for example, a time value less than or equal to 0.5 seconds, but is not limited thereto. In addition, in some embodiments, the reverse operation constant torque value may be preset to cause the reverse operation torque generated for driving the integrated starter and generator 130 to be greater than the frictional resistance value of the crankshaft of the motorcycle engine 200 and less than the maximum resistance value of the valve spring resistance of the crankshaft of the motorcycle engine 200. Specifically, the reverse operation constant torque value may be, for example, a torque value between 3 N·m and 4 N·m, but is not limited thereto.

Using an example in which the motorcycle engine 200 is the foregoing 125 cc four-stroke single-cylinder gasoline engine, the reverse operation time may be preset to, for example, 0.5 seconds, and the reverse operation constant torque value may be preset to, for example, 3 N·m or 4 N·m. However, this application is not limited thereto.

It should be noted that, the foregoing reverse operation time may be set to different time values according to different motorcycle engines 200. Similarly, the forgoing reverse operation constant torque value also may be set to different torque values according to different motorcycle engines 200.
Step S220: Control, through the controller 110, the power supply apparatus 120 to output a forward operation constant current to the integrated starter and generator 130 after the integrated starter and generator 130 stops the reverse operation, to drive the integrated starter and generator 130 to perform forward operation, where a forward operation torque of the integrated starter and generator 130 driven by an amount of the forward operation constant current is greater than a sum of the frictional resistance value and a current resistance value of the valve spring resistance. In other words, after step S210 is performed, the integrated starter and generator 130 stops the reverse operation as the reverse operation time ends. In this case, the integrated starter and generator enters a state of stopping operation and waiting for starting. By performing step S220, the controller 110 controls the power supply apparatus 120 to output the forward operation constant current to the integrated starter and generator 130, thereby driving the integrated starter and generator 130 to perform the forward operation by using the outputted forward operation constant current, and driving the crankshaft of the motorcycle engine 200 to rotate, to start the motorcycle engine 200.

In some embodiments, the foregoing amount of the forward operation constant current may be preset to cause the forward operation torque generated for driving the integrated starter and generator 130 to be greater than the sum of the frictional resistance value of the crankshaft of the motorcycle engine 200 and the current resistance value of the valve spring resistance of the crankshaft of the motorcycle engine 200. Specifically, the amount of the forward operation constant current may be, for example, a current value between 60 amperes and 80 amperes, but is not limited thereto.

Using an example in which the motorcycle engine 200 is the foregoing 125 cc four-stroke single-cylinder gasoline engine, the amount of the forward operation constant current may be preset to, for example, 60 amperes, 70 amperes, or 80 amperes, but is not limited thereto. It should be noted that, the amount of the forward operation constant current also may be set to different current values according to different motorcycle engines 200.
Step S230: Start the motorcycle engine 200 through the integrated starter and generator 130 when a forward operation angular velocity value of the motorcycle engine 200 driven by the integrated starter and generator 130 is greater than or equal to an expected value during a period in which the integrated starter and generator 130 performs the forward operation. In other words, as the integrated starter and generator 130 performs the forward operation and drives the crankshaft of the motorcycle engine 200 to rotate accordingly, if the forward operation angular velocity value of the crankshaft of the motorcycle engine 200 after the crankshaft is driven by the integrated starter and generator 130 is greater than or equal to the expected value, the motorcycle engine 200 is started through the integrated starter and generator 130, to enable the motorcycle engine 200 to function, that is, enable the motorcycle engine 200 to be successfully ignited and operated.

In some embodiments, the expected value may be, for example, an angular velocity value of 47 radians per second (47 rad/s) or 450 revolutions per minute (450 RPM), but is not limited thereto. Using an example in which the motorcycle engine 200 is the foregoing 125 cc four-stroke single-cylinder gasoline engine, the expected value may be, for example, 450 RPM, but is not limited thereto. It should be noted that, the foregoing expected value may be different according to different motorcycle engines 200.

After the motorcycle engine 200 is successfully ignited and operated, an idling rotating speed of the motorcycle engine 200 is automatically increased to 1,500 revolutions per minute (1,500 RPM) due to the ignition and operation.

By using the steps shown in FIG. 2, the crankshaft of the motorcycle engine 200 may be driven to a position at which the resistance to be overcome is relatively small, and then the crankshaft of the motorcycle engine 200 may be driven to rotate with a relatively small amount of current, thereby successfully starting the motorcycle engine 200. In this way, in a case that a positioning sensor, for example, a crankshaft positioning sensor, does not need to be additionally installed on the motorcycle engine 200, the motorcycle engine 200 can be started with a relatively small amount of current, thereby effectively reducing costs of starting the motorcycle engine 200.

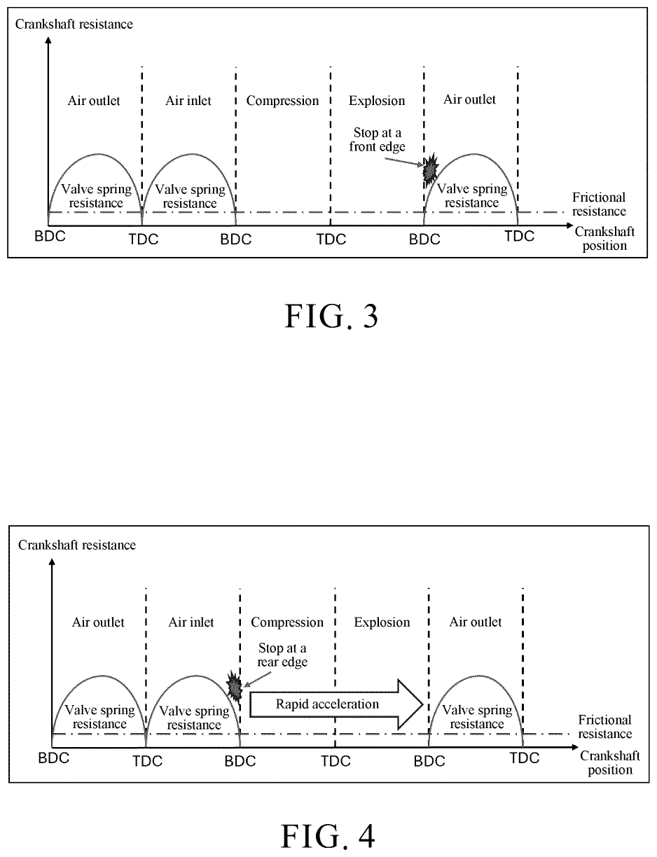

Referring to FIG. 3 and FIG. 4, FIG. 3 and FIG. 4 are schematic diagrams of waveforms of a relationship between a crankshaft position and crankshaft resistance.

As the speed of the motorcycle engine 200 increases, the valve spring resistance of the crankshaft of the motorcycle engine 200 generally increases. When the motorcycle engine 200 is stalled, remaining rotational inertia of the crankshaft of the motorcycle engine 200 mostly causes the crankshaft of the motorcycle engine 200 to stop at a front edge of the valve spring resistance in a second air outlet interval shown in FIG. 3. This position is quite disadvantageous for starting the motorcycle engine 200, that is, the integrated starter and generator 130 needs to require a larger amount of current and/or more time to successfully start the motorcycle engine 200. More specifically, this position causes the integrated starter and generator 130 to require a larger torsional force to first overcome the sum of the frictional resistance value and the maximum resistance value of the valve spring resistance, and then a torsional force left after overcoming the sum can be provided for a flywheel magneto to perform acceleration, thereby enabling the flywheel magneto to generate a sufficient speed and sufficient rotational inertia to overcome compression resistance, so that the motorcycle engine 200 is combusted through compression and ignition and operates normally.

To overcome the foregoing situation, by performing step S210 shown in FIG. 2, the crankshaft of the motorcycle engine 200 may be driven, through the reverse operation of the integrated starter and generator 130, from the front edge of the valve spring resistance in the second air outlet interval show in FIG. 3 to the rear edge of the valve spring resistance in the air inlet interval shown in FIG. 4, so that the resistance that needs to be overcome when the motorcycle engine 200 is started subsequently can be reduced, and the motorcycle engine 200 can be started with a relatively small amount of current in a case that the positioning sensor, for example, the crankshaft positioning sensor does not need to be additionally installed on the motorcycle engine 200, thereby effectively reducing costs of starting the motorcycle engine 200.

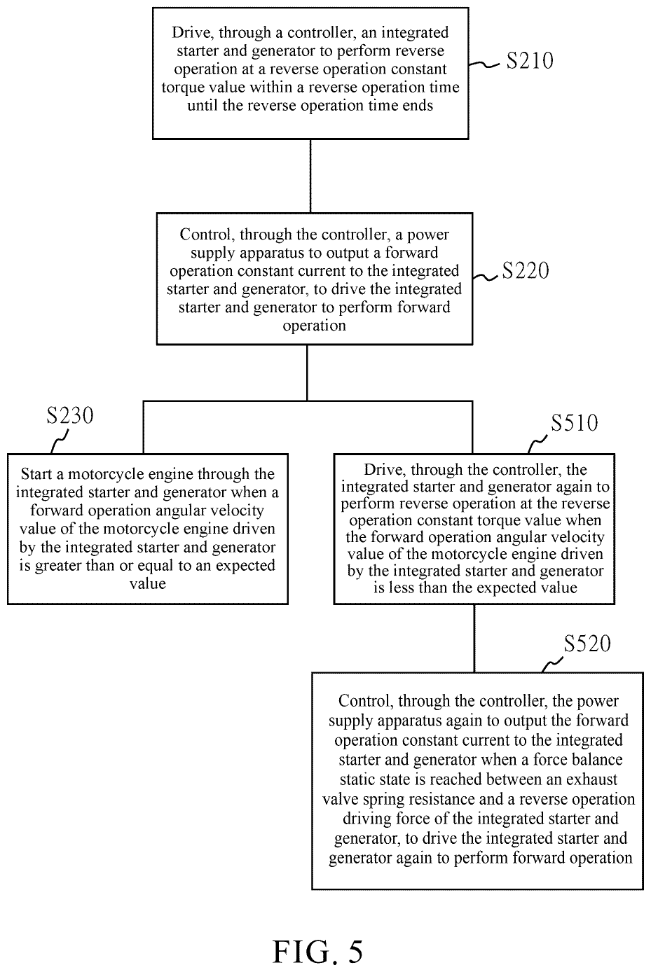

Referring to FIG. 5, FIG. 5 is a flowchart of a method for starting a motorcycle engine according to a second embodiment of this application. Using FIG. 5 as an example, the method for starting a motorcycle engine may be performed by using the system 100 for starting a motorcycle engine shown in FIG. 1, where the method may include the steps S210, S220, and S230 shown in FIG. 2, and further include steps S510 and S520. The steps that are further included in FIG. 5 are respectively described in more detail below.

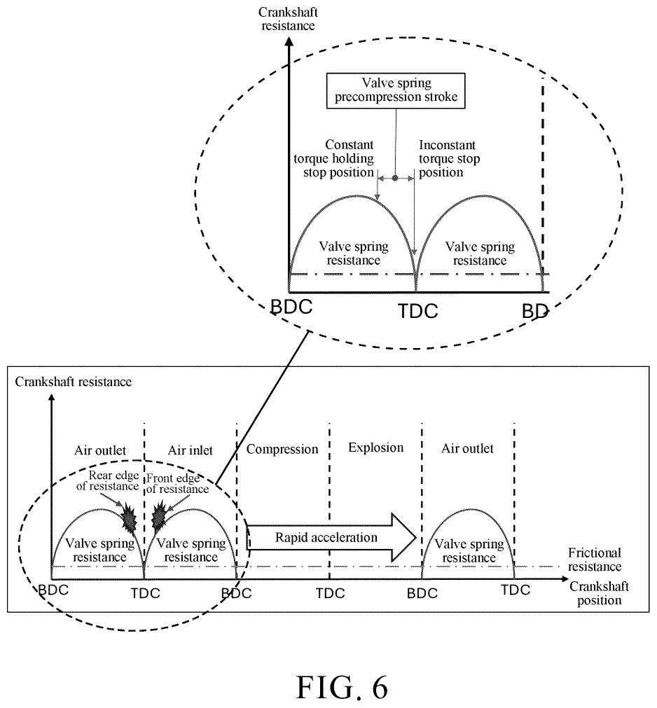

In some embodiments, step S510 may be performed after step S220, and step S520 may be performed after step S510.
Step S510: Drive, through the controller 110, the integrated starter and generator 130 again to perform reverse operation at the reverse operation constant torque value when the forward operation angular velocity value of the motorcycle engine 200 driven by the integrated starter and generator 130 is less than the expected value during the forward operation of the integrated starter and generator 130. More specifically, although the crankshaft of the motorcycle engine 200 generally stops at the front edge of the valve spring resistance in the second air outlet interval shown in FIG. 3 during the stalling, in few cases, the crankshaft of the motorcycle engine may stop between a rear edge of the valve spring resistance in a first air outlet interval and a front edge of the valve spring resistance in an air inlet interval shown in FIG. 6. As a result, the forward operation angular velocity value of the motorcycle engine 200 driven by the integrated starter and generator 130 during the forward operation is less than the expected value (for example, an angular velocity value of 47 rad/s or 450 RPM, but is not limited thereto). To resolve this situation, by performing step S510, the controller 110 drives the integrated starter and generator 130 again to perform reverse operation at the foregoing reverse operation constant torque value (for example, a torque value between 3 N·m and 4 N·m, but is not limited thereto), so that the crankshaft of the motorcycle engine 200 is driven, through the reverse operation, to a specific position, that is, a constant torque holding stop position on a rear edge of the valve spring resistance in the first air outlet interval shown in FIG. 6 below.
Step S520: Control, through the controller, the power supply apparatus 120 again to output the forward operation constant current to the integrated starter and generator 130 when a force balance static state is reached between an exhaust valve spring resistance and a reverse operation driving force of the integrated starter and generator 130 during a period in which the integrated starter and generator 130 performs the reverse operation again, to drive the integrated starter and generator 130 again to perform forward operation. In other words, as the integrated starter and generator 130 performs the reverse operation again and drives the crankshaft of the motorcycle engine 200 to rotate accordingly, if the force balance static state is reached between the exhaust valve spring resistance and the reverse operation driving force of the integrated starter and generator 130 in this case (which causes the crankshaft of the motorcycle engine 200 to stop at the constant torque holding stop position on the rear edge of the valve spring resistance in the first air outlet interval shown in FIG. 6 below), the controller 110 immediately controls the power supply apparatus 120 to output the foregoing forward operation constant current (for example, a current value between 60 amperes and 80 amperes, but is not limited thereto) to the integrated starter and generator 130 again, to drive the integrated starter and generator 130 again to perform the forward operation, so that the motorcycle engine 200 can be started through a torsional force generated during the forward operation of the integrated starter and generator 130 and a reaction force of the exhaust valve spring resistance.

By using the steps shown in FIG. 5, regardless of a front edge of the valve spring resistance at which the crankshaft of motorcycle engine 200 stops during the stalling, the crankshaft of motorcycle engine 200 can be driven with a relatively small amount of current to rotate, thereby successfully starting the motorcycle engine 200. In this way, in a case that the positioning sensor, for example, the crankshaft positioning sensor, does not need to be additionally installed on the motorcycle engine 200, the motorcycle engine 200 can be started with a relatively small amount of current, thereby effectively reducing costs of starting the motorcycle engine 200 and starting the motorcycle engine 200 reliably.

Referring to FIG. 6, FIG. 6 is a schematic diagram of a waveform of a relationship between a crankshaft position and crankshaft resistance.

In practice, the crankshaft of the motorcycle engine 200 may stop at the front edge of the valve spring resistance during the stalling, most of the crankshaft stops at the front edge of the valve spring resistance in the second air outlet interval shown in FIG. 3, while a small part of the crankshaft stops between two adjacent valve spring resistance, that is, between the rear edge of the valve spring resistance in the first air outlet interval and the front edge of the valve spring resistance in the air inlet interval shown in FIG. 6. As a result, the forward operation angular velocity value of the motorcycle engine 200 driven by the integrated starter and generator 130 during the forward operation is less than the expected value.

To overcome the forgoing situation, by performing step S510 shown in FIG. 5, the crankshaft of the motorcycle engine 200 may be driven again, through the reverse operation of the integrated starter and generator 130, to the constant torque holding stop position on the rear edge of the valve spring resistance in the first air outlet interval shown in FIG. 6. In this way, the motorcycle engine 200 can be started by using an acceleration region that is increased by a valve spring precompression stroke between the constant torque holding stop position and an inconstant torque stop position shown in FIG. 6.

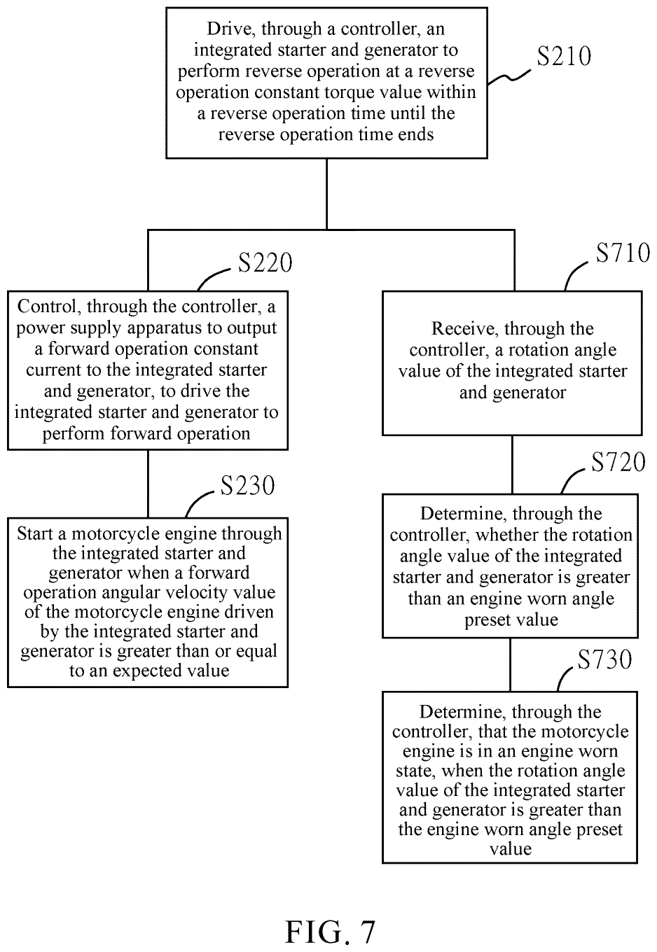

Referring to FIG. 7, FIG. 7 is a flowchart of a method for starting a motorcycle engine according to a third embodiment of this application. Using FIG. 7 as an example, the method for starting a motorcycle engine may be performed by using the system 100 for starting a motorcycle engine shown in FIG. 1, where the method may include the steps S210, S220, and S230 shown in FIG. 2, and further include steps S710, S720, and S730. The steps that are further included in FIG. 7 are respectively described in more detail below.
Step S710: Receive, through the controller 110, a rotation angle value of the integrated starter and generator 130. In some embodiments, step S710 may be performed after step S210; and in addition, step S710 may be performed continuously, and is not limited to being performed only after a specific step. In other words, by performing step S710, the controller 110 may receive the rotation angle value of the integrated starter and generator 130 from the integrated starter and generator 130.
Step S720: Determine, through the controller 110, whether the rotation angle value of the integrated starter and generator 130 is greater than an engine worn angle preset value when the integrated starter and generator 130 stops the reverse operation as the reverse operation time ends. In some embodiments, step S720 may be performed after steps S210 and S710. More specifically, after step S210 is performed, the controller 110 may determine, according to the rotation angle value of the integrated starter and generator 130 received by performing step S710, whether the rotation angle value of the integrated starter and generator 130 is greater than the engine worn angle preset value, to autonomously check whether the motorcycle engine 200 is in an engine worn state. In some embodiments, the worn angle preset value may be preset to, for example, 300 degrees, but is not limited thereto.
Step S730: Determine, through the controller 110, that the motorcycle engine 200 is in the engine worn state when the rotation angle value of the integrated starter and generator 130 is greater than the engine worn angle preset value. In some embodiments, step S730 may be performed after step S720. In other words, when the rotation angle value of the integrated starter and generator 130 is greater than the foregoing engine worn angle preset value, the controller 110 may determine that the motorcycle engine 200 is in the engine worn state, to notify a user and/or maintenance personnel to perform corresponding processing. On the contrary, when the rotation angle value of the integrated starter and generator 130 is less than or equal to the foregoing engine worn angle preset value, the controller 110 may determine that the motorcycle engine 200 is not in the engine worn state, that is, is in a normal state.

By using the steps shown in FIG. 7, in a process of starting the motorcycle engine 200, whether the motorcycle engine 200 is worn can be further autonomously checked, to notify the user and/or maintenance personnel in real time to perform corresponding processing, thereby avoiding hazard and/or inconvenience caused by the worn engine.

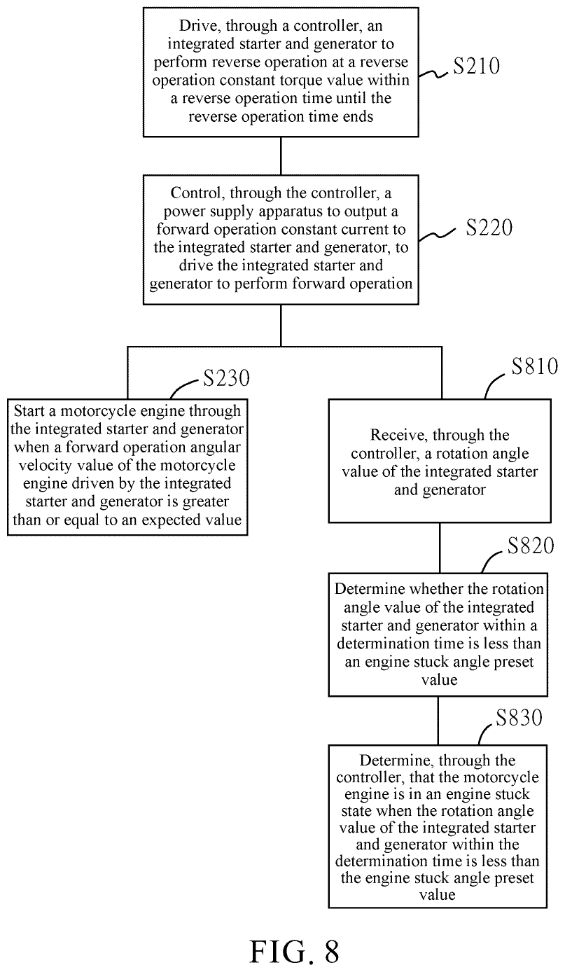

Referring to FIG. 8, FIG. 8 is a flowchart of a method for starting a motorcycle engine according to a fourth embodiment of this application. Using FIG. 8 as an example, the method for starting a motorcycle engine may be performed by using the system 100 for starting a motorcycle engine shown in FIG. 1, where the method may include the steps S210, S220, and S230 shown in FIG. 2, and further include steps S810, S820, and S830. The steps that are further included in FIG. 8 are respectively described in more detail below.
Step S810: Receive, through the controller 110, a rotation angle value of the integrated starter and generator 130. In some embodiments, step S810 may be performed after step S220; and in addition, step S810 may be performed continuously, and is not limited to being performed only after a specific step. In other words, by performing step S810, the controller 110 may receive the rotation angle value of the integrated starter and generator 130 from the integrated starter and generator 130.
Step S820: Determine, through the controller 110, whether the rotation angle value of the integrated starter and generator 130 within a determination time is less than an engine stuck angle preset value when the integrated starter and generator 130 performs the forward operation. In some embodiments, step S820 may be performed after steps S220 and S810. More specifically, as the integrated starter and generator 130 performs the forward operation, the controller 110 may determine, according to the rotation angle value of the integrated starter and generator 130 received by performing S810, whether the rotation angle value of the integrated starter and generator 130 within the determination time is less than the engine stuck angle preset value, to autonomously check whether the motorcycle engine 200 is in an engine stuck state.

In some embodiments, the foregoing determination time may be preset to, for example, 0.5 seconds, but is not limited thereto. In some embodiments, the foregoing engine stuck angle preset value may be determined according to a quantity of rotor pole pairs (Pole Pairs) of the integrated starter and generator 130. That is, the engine stuck angle preset value may be preset to a calculation result (for example, 45 degrees) of dividing 360 degrees by the forgoing quantity of the rotor pole pairs (for example, 8 pairs), but is not limited thereto.
Step S830: Determine, through the controller 110, that the motorcycle engine 220 is in the engine stuck state when the rotation angle value of the integrated starter and generator 130 within the determination time is less than the engine stuck angle preset value. In some embodiments, step S830 may be performed after step S820. In other words, when the rotation angle value of the integrated starter and generator 130 within the foregoing determination time is less than the foregoing engine stuck angle preset value, the controller 110 may determine that the motorcycle engine 200 is in the engine stuck state, to notify a user and/or maintenance personnel to perform corresponding processing. On the contrary, when the rotation angle value of the integrated starter and generator 130 within the foregoing determination time is greater than or equal to the foregoing engine stuck angle preset value, the controller 110 may determine that the motorcycle engine 200 is not in the engine stuck state, that is, is in a normal state.

By performing the steps shown in FIG. 8, in a process of starting the motorcycle engine 200, whether the motorcycle engine 200 is stuck can be further autonomously checked, to notify the user and/or maintenance personnel in real time to perform corresponding processing, thereby avoiding hazard and/or inconvenience caused by the stuck engine.

<<An Example in which the Motorcycle Engine 200 is a 125 cc Four-Stroke Single-Cylinder Gasoline Engine>>

When the motorcycle engine 200 is stalled, the crankshaft of the motorcycle engine 200 may stops at the front edge of the valve spring resistance. In this case, by performing step S210, the controller 110 may drive the integrated starter and generator 130 to perform the reverse operation at a reverse operation constant torque value of between 3 N·m and 4 N·m within a reverse operation time of 0.5 seconds, so as to drive the crankshaft of the motorcycle engine 200 to the rear edge of the valve spring resistance, and push the crankshaft of the motorcycle engine forward by a small angle value due to a reaction force of the valve spring resistance.

Next, after step S210 is performed, the integrated starter and generator 130 stops the reverse operation as the reverse operation time ends, and enters a state of stopping operating and waiting for starting. By performing step S220, the controller 110 controls the power supply apparatus 120 to output a forward operation constant current between 60 amperes to 80 amperes to the integrated starter and generator 130, so as to drive the integrated starter and generator 130 to perform the forward operation.

Next, as the integrated starter and generator 130 performs the forward operation and drives the crankshaft of the motorcycle engine 200 to rotate, if the forward operation angular velocity value of the crankshaft of the motorcycle engine 200 that is driven by the integrated starter and generator 130 is greater than or equal to an expected value of 450 RPM, the motorcycle engine 200 is started, so that the motorcycle engine 200 automatically increases to an idling rotating speed of 1,500 RPM due to ignition and operation.

In addition, if the forward operation angular velocity value of the crankshaft of the motorcycle engine 200 that is driven by the integrated starter and generator 130 is less than the expected value of 450 RPM, it refers to the crankshaft of the motorcycle engine 200 is between two adjacent valve spring resistance. To resolve this situation, by performing step S510, the controllers 110 may drive the integrated starter and generator 130 again to perform the reverse operation at a reverse operation constant torque value between 3 N·m and 4 N·m, so as to drive the crankshaft of the motorcycle engine 200 to the constant torque holding stop position at the rear edge of the first valve spring resistance of the two adjacent valve spring resistance. In this case, a force balance static state is reached between the exhaust valve spring resistance and the reverse operation driving force of the integrated starter and generator 130.

Next, by performing step S520, the controller 110 immediately control the power supply apparatus 120 to output a forward operation constant current between 60 amperes and 80 amperes to the integrated starter and generator 130 again, so as to drive the integrated starter and generator 130 to perform the forward operation in time. Beneficial to a torsional force generated during the forward operation of the integrated starter and generator 130, a reaction force of the exhaust valve spring resistance, and the like, the crankshaft of the motorcycle engine 200 is driven to an angular velocity value greater than or equal to 450 RPM, so that the motorcycle engine 200 automatically increases to an idling rotating speed of 1,500 RPM due to ignition and operation.

In some embodiments, steps of the method for starting the motorcycle engine described in this application may be further combined, replaced, repeatedly performed, and/or modified, to generate new embodiments without exceeding the scope disclosed in this application.

This application has been further described through the above embodiments and accompanying drawings, but those of ordinary skill in the art to which this application belongs can still make many modifications and changes without departing from the scope and spirit set forth in the claims of this application. Therefore, the scope of protection of this application shall still be defined by the claims, and shall not be limited by the contents disclosed in the specification.

While the present disclosure has been described by means of specific embodiments, numerous modifications and variations could be made thereto by those skilled in the art without departing from the scope and spirit of the present disclosure set forth in the claims.

What is claimed is:

1. A method for starting a motorcycle engine, performed through an engine starting control system, wherein the engine starting control system comprises a controller, a power supply apparatus coupled to the controller, and an integrated starter and generator separately coupled to the controller and the power supply apparatus, the integrated starter and generator in the engine starting control system is coupled to a motorcycle engine, and the method comprises the following steps:
driving, through the controller, the integrated starter and generator to perform reverse operation at a reverse operation constant torque value within a reverse operation time until the reverse operation time ends, wherein a reverse operation torque of the integrated starter and generator driven by the reverse operation constant torque value is greater than a frictional resistance value and less than a maximum resistance value of a valve spring resistance;
controlling, through the controller, the power supply apparatus to output a forward operation constant current to the integrated starter and generator after the integrated starter and generator stops the reverse operation, to drive the integrated starter and generator to perform forward operation, wherein a forward operation torque of the integrated starter and generator driven by an amount of the forward operation constant current is greater than a sum of the frictional resistance value and a current resistance value of the valve spring resistance; and
starting the motorcycle engine through the integrated starter and generator when a forward operation angular velocity value of the motorcycle engine driven by the integrated starter and generator is greater than or equal to an expected value during the forward operation of the integrated starter and generator.

2. The method according to claim 1, wherein the method further comprises the following steps:
driving, through the controller, the integrated starter and generator again to perform the reverse operation at the reverse operation constant torque value when the forward operation angular velocity value of the motorcycle engine driven by the integrated starter and generator is less than the expected value during the forward operation of the integrated starter and generator; and
controlling, through the controller, the power supply apparatus again to output the forward operation constant current to the integrated starter and generator when a force balance static state is reached between an exhaust valve spring resistance and a reverse operation driving force of the integrated starter and generator during a period in which the integrated starter and generator performs the reverse operation again, to drive the integrated starter and generator again to perform the forward operation.

3. The method according to claim 1, wherein the method further comprises the following steps:
receiving, through the controller, a rotation angle value of the integrated starter and generator;
determining, through the controller, whether the rotation angle value of the integrated starter and generator is greater than an engine worn angle preset value when the integrated starter and generator stops the reverse operation as the reverse operation time ends; and
determining, through the controller, that the motorcycle engine is in an engine worn state when the rotation angle value of the integrated starter and generator is greater than the engine worn angle preset value.

4. The method according to claim 1, wherein the method further comprises the following steps:
receiving, through the controller, a rotation angle value of the integrated starter and generator;
determining, through the controller, whether the rotation angle value of the integrated starter and generator within a determination time is less than an engine stuck angle preset value when the integrated starter and generator performs the forward operation; and
determining, through the controller, that the motorcycle engine is in an engine stuck state when the rotation angle value of the integrated starter and generator within the determination time is less than the engine stuck angle preset value.

5. The method according to claim 1, wherein the engine starting control system does not comprise a crankshaft positioning sensor.

6. A system for starting a motorcycle engine, wherein the system is coupled to the motorcycle engine, and the system comprises:
a controller;
a power supply apparatus, coupled to the controller; and
an integrated starter and generator, separately coupled to the controller, the power supply apparatus, and the motorcycle engine,
wherein the system is configured to perform the method for starting a motorcycle engine according to claim 1, to start the motorcycle engine.

7. A system for starting a motorcycle engine, wherein the system is coupled to the motorcycle engine, and the system comprises:
a controller;
a power supply apparatus, coupled to the controller; and
an integrated starter and generator, separately coupled to the controller, the power supply apparatus, and the motorcycle engine,
wherein the system is configured to perform the method for starting a motorcycle engine according to claim 2, to start the motorcycle engine.

8. A system for starting a motorcycle engine, wherein the system is coupled to the motorcycle engine, and the system comprises:
a controller;
a power supply apparatus, coupled to the controller; and
an integrated starter and generator, separately coupled to the controller, the power supply apparatus, and the motorcycle engine,
wherein the system is configured to perform the method for starting a motorcycle engine according to claim 3, to start the motorcycle engine.

9. A system for starting a motorcycle engine, wherein the system is coupled to the motorcycle engine, and the system comprises:
a controller;
a power supply apparatus, coupled to the controller; and
an integrated starter and generator, separately coupled to the controller, the power supply apparatus, and the motorcycle engine,
wherein the system is configured to perform the method for starting a motorcycle engine according to claim 4, to start the motorcycle engine.

10. The system according to claim 6, wherein the system does not comprise a crankshaft positioning sensor.

11. The system according to claim 7, wherein the system does not comprise a crankshaft positioning sensor.

12. The system according to claim 8, wherein the system does not comprise a crankshaft positioning sensor.

13. The system according to claim 9, wherein the system does not comprise a crankshaft positioning sensor.
